(19) United States
(12) Patent Application Publication
(10) Pub. No.: US 2014/0040008 A1
(43) Pub. Date: Feb. 6, 2014

(54) INTER-CAMPAIGN ADVERTISING MANAGEMENT

(71) Applicants: Eshwar Belani, San Jose, CA (US); Richard Frankel, San Francisco, CA (US)

(72) Inventors: Eshwar Belani, San Jose, CA (US); Richard Frankel, San Francisco, CA (US)

(73) Assignee: Rocket Fuel, Inc., Redwood City, CA (US)

(21) Appl. No.: 14/006,076

(22) PCT Filed: Jun. 27, 2012
(86) PCT No.: PCT/US12/44343

§ 371 Date: Oct. 10, 2013

Related U.S. Application Data
(60) Provisional application No. 61/501,491, filed on Jun. 27, 2011.

(51) Int. Cl. G06Q 30/02

(52) U.S. Cl. CPC G06Q 30/0242
USPC 705/14.41

(57) ABSTRACT

Techniques are provided for adapting an advertising campaign based on real-time analysis of campaign metrics for a concurrent advertising campaign. As one advertising campaign runs, parameters of the campaign are updated to incorporate insights from another advertising campaign. In one embodiment, parameters of the campaign are updated to boost performance of a portion of the advertising campaign determined to be particularly responsive based on the campaign metrics from another campaign. The campaign metrics may be measured using real-time, single-question surveys across segmented portions of the target audience and may be used to generate correlations between the target audience and marketing objectives sought.

### BACKGROUND

1. Field of the Invention

The present invention relates to the field of online advertising and, in particular, to a method for inter-campaign management of online advertising.

2. Description of the Related Art

Generally, advertising campaigns may be conducted to achieve a number of marketing objectives with customers on a variety of scales or levels. In one approach, a customer-focused marketing model, sometimes referred to as a “purchasing funnel,” utilizes the following sequential marketing objectives: (1) raising awareness of the existence of a brand or product, (2) increasing a customer's favorability towards a brand or product, (3) increasing a customer's active consideration of a particular brand or product (e.g., through demonstrations, test-drives), (4) increasing the intent of a customer to purchase a particular brand/product, (5) generating prospective customer information, often referred to as “leads,” and (6) driving sales of the particular brand or product. In another approach, advertising campaigns may be arranged based on a brand's underlying organization. For example, a multi-national automobile corporation may run a national advertising campaign to raise awareness of the brand nationwide, while regional automobile organizations may run regional advertising to generate leads and sales in their respective area, and individual dealers may run campaigns for a particular dealership.

Also, to achieve various marketing objectives, advertisers may rely on different types of advertising campaigns. Advertisers may conduct advertising campaigns with a strong emphasis on a particular brand (e.g., a company's or product logo and/or name) to influence the preferences and behavior of a wide audience. This type of advertising, often referred to as “brand advertising,” may be designed to raise awareness of and/or promote goodwill and familiarity towards that particular brand. In contrast, “direct response” advertising is generally conducted to generate leads and/or sales, and to achieve other specific, quantifiable business results.

As a result, users may be exposed to numerous advertising messages from various advertising campaigns all related to the same brand and/or product. The numerous advertising messages may include campaign messages spanning across multiple products of the same company, messages having new announcements, messages describing features, and benefits, sales events, promotions, and deals. However, different advertising campaigns, though they may be for the same or similar brand and/or product(s), are often run independently of each other with separate budgets, marketing targets, buying power, etc. Users may receive repetitive, irrelevant, and misaligned advertising messages that result in a poor user experience with a brand and/or product. As such, techniques and methods for executing coordinated advertising campaigns that integrate and share insight and knowledge across campaigns are desirable.

### SUMMARY

Embodiments of the invention provide techniques for managing an advertising campaign based on insights determined from another advertising campaign. Embodiments may deliver display advertising utilizing techniques that connect awareness and consideration-building campaigns with direct response, “in-the-market-for” (sometimes referred to as “in-market”) shopping campaigns. Embodiments of the invention may be utilized for advertising in “vertical” markets, such as consumer packaged goods (CPG), automobiles, retail, education, travel, among others. Embodiments of the invention provide advertising campaigns that are tailored and scaled in real-time to leverage insights across different stages of the customer lifecycle for an integrated cross-campaign strategy that efficiently brings prospective customers through the “purchasing funnel.”

Embodiments of the invention provide a method for managing advertising campaigns. The method generally includes providing advertising content associated with a first advertising campaign to a plurality of users based on a first set of campaign parameters and generating an analysis of the first advertising campaign based on one or more campaign metrics, wherein the one or more campaign metrics are indicative of an impact on the first advertising on at least one of the plurality of users. The method further includes updating a second set of campaign parameters for a second advertising campaign based on the analysis of the first advertising campaign.

Embodiments of the invention provide a computer-readable storage medium storing instructions that, when executed by a processor, performs an operation for managing advertising campaigns. The operation generally includes providing advertising content associated with a first advertising campaign to a plurality of users based on a first set of campaign parameters and generating an analysis of the first advertising campaign based on one or more campaign metrics, wherein the one or more campaign metrics are indicative of an impact on the first advertising on at least one of the plurality of users. The operation further includes updating a second set of campaign parameters for a second advertising campaign based on the analysis of the first advertising campaign.

Embodiments of the invention provide a method for administering a plurality of advertising campaigns. The method generally includes determining an audience segment associated with a user and selecting an ad for the user based on one or more campaign parameters of a first advertising campaign. The method further includes determining a score for one or more brand metrics based on feedback from the user of the first advertising campaign, generating an analysis of the first advertising campaign based on the audience segment and the score for one or more brand metrics, and updating at least one campaign parameter of a second advertising campaign based on the analysis.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a computing system configured for delivering online advertising, according to one embodiment of the invention.

FIG. 2 is a more detailed view of the campaign server of FIG. 1 within which embodiments of the invention may be implemented.

FIG. 3 depicts an exemplary web page document having online advertising provided by techniques according to certain aspects of the present disclosure.

FIG. 4 is a flow diagram of method steps for operating multiple advertising campaigns having cross-campaign adaptation, according to one embodiment of the invention.

FIG. 5 is a block diagram illustrating multiple advertising campaigns managed according to certain aspects of present disclosure.

FIG. 6 is a block diagram illustrating multiple advertising campaigns based on a purchasing funnel model that may be executed by embodiments of the invention.

FIG. 7 illustrates an example operation for generating insight of a brand awareness advertising campaign according to certain aspects of present disclosure.

FIG. 8 is a block diagram illustrating multiple tiered advertising campaigns that may be executed using embodiments of the invention.

FIGS. 9-10 illustrate examples of vertical advertising campaigns that may be utilized by certain embodiments of the invention.

FIG. 11 is a flow diagram of method steps for serving advertising to a user utilizing a technique for cross-campaign adaptation, according to certain aspects of the present disclosure.

FIGS. 12A and 12B show and example of the non-linear flow that can occur during advertising campaigns.

### DETAILED DESCRIPTION

Embodiments on the invention provide a technique for online advertising utilizing cross-campaign adaptation to achieve the marketing objectives of multiple advertising campaigns. Embodiments of the invention provide techniques that enable synergies between advertising campaigns in real-time and coordinate campaigns between advertising channels (e.g., web, video, mobile, social). Embodiments of the invention also provide a record of customers' message exposure, engagement, and/or response across a plurality of advertising campaigns to provide consistent messaging to users.

In some embodiments, the effect of exposure to advertising for a first advertising campaign on one or more users may be monitored, for example, through use of a single question survey. The results of first campaign's effect may be aggregated and analyzed to determine insights regarding the target audience of the first advertising campaign. Embodiments of the invention may then adapt a second advertising campaign while both the first and second campaigns are ongoing based on the determined insights of the first advertising campaign.

In one embodiment, recipients of an advertising campaign may be grouped into a plurality of different “audience segments.” An audience segment is an abstract entity that represents a targeting tactic, an external user segment, a creative unit, a category of inventory on an ad exchange, or other user partitioning scheme. As one campaign runs and the effects on audience segments are measured, insights regarding poorly performing segments or better-performing segments may be utilized for scaling impression delivery in the other advertising campaign.

As used throughout the description, the term ‘segment’ should be understood to encompass a broad group rather than simply an audience focused segment. A ‘segment’ could pertain to a combination of audience characteristics, contextual attributes, ad inventory and channel sources, time, creative elements and other attributes (i.e., weather, stock market updates, etc.). A ‘segment’ is to be understood to include attributes such as users consuming a certain category of content (e.g., auto related content), users using a certain channel (e.g. mobile), weather based conditions (e.g. targeting all users where it is raining for a windshield wiper campaign), etc.

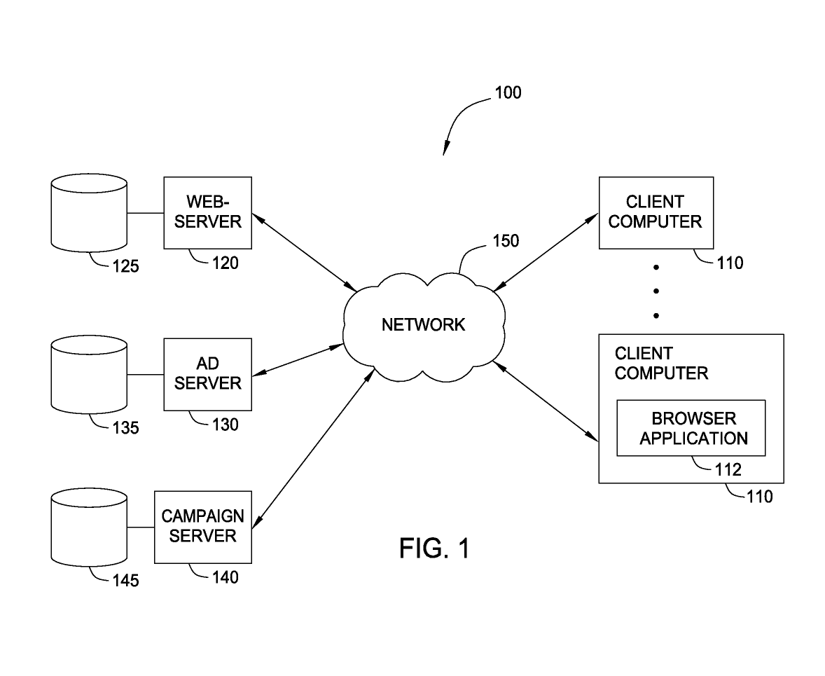

FIG. 1 illustrates a computing system 100 configured for delivering online advertising, according to one embodiment of the invention. As shown, the computing system 100 includes a web server 120, an ad server 130, a campaign server 140, and a plurality of client computers 110 (only two of which are shown for clarity), each connected to a communications network 150 (e.g., the Internet). For example, the web server 120 may be programmed to communicate with the client computers 110, the ad server 130, and the campaign server 140 using a networking protocol such as TCP/IP protocol.

Each client computer 110 may include conventional components of a computing device, e.g., a processor, system memory, a hard disk drive, input devices such as a mouse, a keyboard, and a touch screen and/or output devices, such as a monitor and audio speakers. The web server 120 includes a processor and a system memory (not shown), and may be configured to manage web pages and other media content stored in its respective content storage unit 125 using a file system and/or a relational database software. The ad server 130 is a specialized web server configured to manage advertising content stored in its respective content storage unit 135. The campaign server 140 is a server configured to manage an advertising campaign utilizing techniques described herein and is described in further detail below.

In the embodiments of the present invention described below, users are respectively operating the client computers 110 that may communicate over the network 150 to request web pages and other media content data from the web server 120. Each client computer 110 may be configured to execute a software application, such as a web browser application 112, and access web pages and/or media content data managed by the web server 120 by specifying a uniform resource locator (URL) for the web server 120 into the web browser application 112. The web pages that are displayed to a user are transmitted from the web server 120 to the user's client computer 110 and processed by the web browser application 112 for display through a monitor of the user's client computer 110.

In one embodiment, the web pages may contain an instruction, often referred to as an “ad tag,” to request advertising content from the ad server 130. In response to processing a web page having an ad tag, the web browser application 112 may be programmed to request advertising content from the ad server 130. The ad server 130 receives advertising requests from web browser applications 112 and retrieves and transmits ad content to the client computers 110. The web browser application 112 may receive the advertising content and display the advertising to the user through the monitor of the user's client computer 110. In one embodiment, the web browser application 112 may display the advertising inline and/or integrated with the requested web page content.

In one embodiment, the ad server 130 may communicate with the campaign server 140 to coordinate selection of ad content to serve to the client computers 110. The ad server 130 may provide to the campaign server 140 the details pertaining to the request of the client computer 110, e.g., by transmitting one or more cookies associated with client computer 110, and the context of the request including but not limited to information about the content on the page the ad will be served, etc. to the campaign server 140. The campaign server 140 administers an advertising campaign and selects ad content associated with the advertising campaign according to techniques described further below. In one embodiment, the campaign server 140 may direct the ad server 130 to serve particular ad content to the client computers 110 by signaling to the ad server 130 at least an advertisement identifier corresponding to the selected ad content.

According to various implementations, the client computer 110 may be a personal computer, laptop, mobile computing device, smart phone, video game console, tablet, home digital media player, network-connected television, set top box, and/or other computing devices having components suitable for communicating with the communications network 150. The client computer 110 may also execute other software applications configured to receive advertising content from the ad server 130, such as, advertising-supported software (“adware”), social applications, computer and video games, media players, and/or widget platforms.

Further, while the ad server 130 is depicted as a single entity in FIG. 1 for sake of discussion, it is understood that the ad server 130 represents an ad-delivering system that may be implemented using a variety of architectures and configurations having multiple components, modules, and/or servers in communication. The ad-delivering system may include ad-delivering servers, ad exchanges, demand side platforms (DSPs), ad networks (horizontal and vertical), analytic platforms, data management platforms, data aggregators, targeted and behavioral advertising platforms, and/or campaign management systems. Additionally, where the campaign server 140 is described herein as providing ad content to a user or customer, it is understood that the campaign server 140 may direct or instruct a third-party component or server, such as the ad server 130, to transmit ad content to the user or customer.

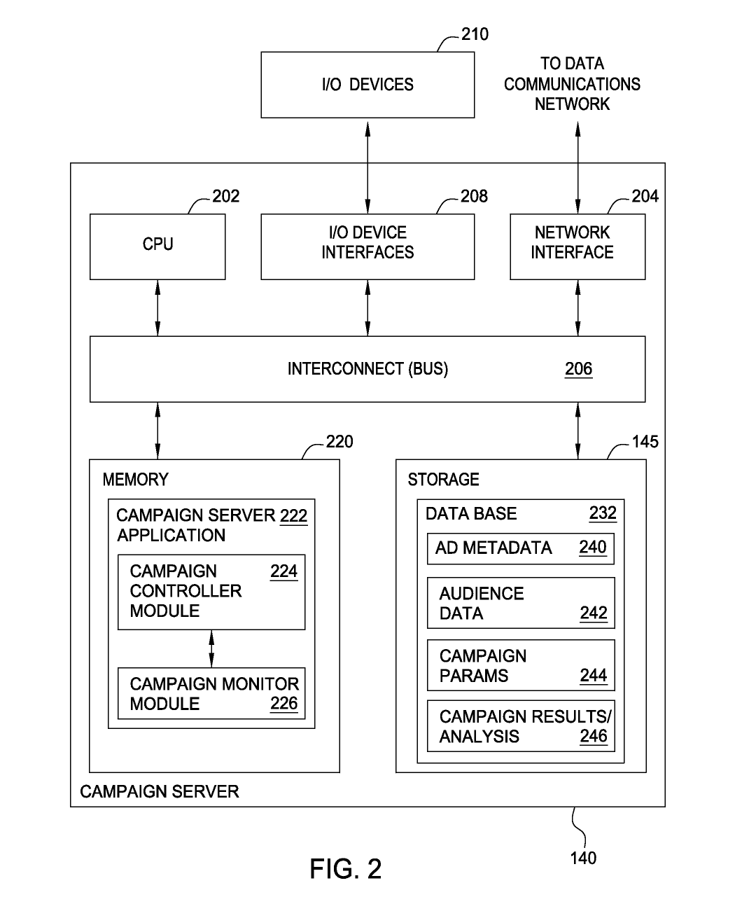

FIG. 2 is a more detailed view of the campaign server 140 of FIG. 1 within which embodiments of the invention may be implemented. As shown, the campaign server 140 includes, without limitation, a central processing unit (CPU) 202, a network interface 204, memory 220, and storage 145 communicating via an interconnect bus 206. The campaign server 140 may also include I/O device interfaces 208 connecting I/O devices 210 (e.g., keyboard, video, mouse, audio). The campaign server 140 may further include a network interface 204 configured to transmit data via the communications network 150.

The CPU 202 retrieves and executes programming instructions stored in the memory 220 and generally controls and coordinates operations of other system components. Similarly, the CPU 202 stores and retrieves application data residing in the memory 220. The CPU 202 is included to be representative of a single CPU, multiple CPUs, a single CPU having multiple processing cores, and the like. The interconnect bus 206 is used to transmit programming instructions and application data between the CPU 202, I/O devices interface 208, storage 145, network interface 204, and memory 220.

The memory 220 is generally included to be representative of a random access memory and, in operation, stores software applications and data for use by the CPU 202. Although shown as a single unit, the storage 145 may be a combination of fixed and/or removable storage devices, such as fixed disc drives, floppy disc drives, hard disk drives, flash memory storage drives, tape drives, removable memory cards, CD-ROM, DVD-ROM, Blu-ray, HD-DVD, optical storage, network attached storage (NAS), or a storage area-network (SAN) configured to store non-volatile data.

According to embodiments of the invention, the memory 220 stores instructions and logic for executing a campaign server application 222. The campaign server application 222 includes a campaign controller module 224 and a campaign monitor module 226. The storage 145 includes a database 232 configured to store data for administering advertising campaigns, such as ad metadata 240 (e.g., advertisement IDs), audience data 242 (e.g., audience segments), campaign parameters 244, and campaign results and analysis 246. In one embodiment, the database 232 comprises a relational database. In other embodiment, the database 232 is any type of storage device.

In one embodiment, the campaign server application 222 responds to requests from ad servers, such as the ad server 130, for determining and selecting advertising content. The campaign controller module 224 manages and administers one or more advertising campaign based on the campaign parameters 244 saved in the storage 145. The campaign controller module 224 processes requests for advertising received from users based on the audience data 242. In one embodiment, the campaign monitor module 226 may be configured to generate campaign results and analysis 246 of ongoing advertising campaigns. The analysis 246 may be generated according to techniques described further below. In one implementation, the campaign monitor module 226 may save the campaign results and analysis 246 in storage 145 for later access and retrieval. The campaign monitor module 226 may also be configured to provide the campaign results and analysis 246 to the campaign controller module 224. In one embodiment, the campaign controller module 224 may be configured to update the campaign parameters 244 based on campaign results and analysis 246.

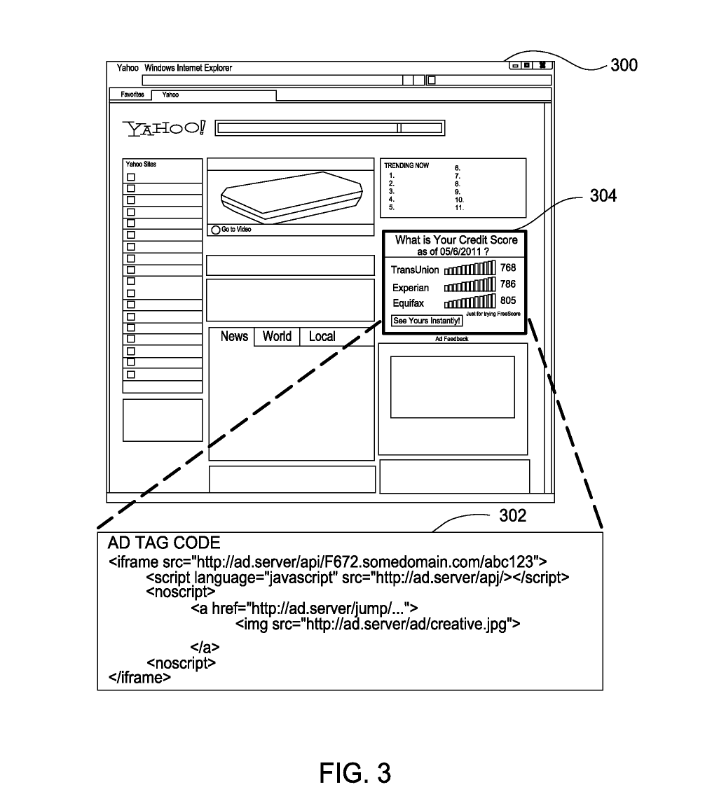

As discussed above, a user may utilize a web browser application 112 to request and access web pages and/or other content from the web server 120. FIG. 3 depicts an exemplary web page document 300 having online advertising provided by techniques according to certain aspects of the present disclosure. The web server 120 may generate the web page document 300. As shown, the web page document 300 includes ad tag code 302 that provides instructions for the web browser application 112 to request advertising content 304 from the ad server 130 when the web page document 300 is processed by the web browser application 112. In one embodiment, the ad server 130 and the campaign server 140 may communicate to coordinate and manage advertising content to be provided to the client computers 110.

Generally, ad tag codes 302 may be implemented as snippets of code or scripting language, such as, Hypertext Markup Language (HTML) or JavaScript, that request the service of advertising content. The ad tag codes 302 may include a reference such as a URL from where the ad content may be requested. In one embodiment, the ad tag code 302 includes a URL having pre-defined parameters encoded in the URL string. In the example shown in FIG. 3, the ad tag code 302 includes programming code that indicates advertising content for the web page document 300 may be requested at the URL seen below:

http://ad.server/api/F672.somedomain.com/abc123

In one embodiment, the web server 120 may provide an ad tag code 302 that is individually configured for a particular client computer 110 or end user. The ad tag code 302 may include an identifier associated with a particular client computer 110 or user. The web browser application 112 may request advertising content from the ad server 130 utilizing the identifier to receive advertising content targeted towards that particular client computer 110 or user. For example, the identifier may comprise a unique string of characters in the URL, such as the string “F672.somedomain.com/abc123” seen in the URL above. As such, the ad server 130 and the campaign server 140 may determine the identity of a client computer 110 or user and/or additional details pertaining to the context of the request (e.g. content category, channel, etc.) based on the unique URL used to request advertising content. In another embodiment, the web browser application 112 may include a persistent session identifier, such as provided by a HTTP “cookie,” with the web browser application's transmissions to the web server 120 and/or ad server 130.

The web browser application 112 is programmed to request and receive the advertising content 304 from the ad server 130. As shown in FIG. 3, the web browser application 112 incorporates the advertising content 304 into the web page document 300 and displays such to the user. The advertising content 304 from the ad server 130 may be display advertising or interactive advertising and may be presented in various forms of media content, including but not limited to, graphical images, video and audio content, text, and/or embedded scripting logic. According to embodiments described below, the advertising content 304 may include an interactive feedback feature, such as a survey questionnaire or single question survey, configured to measure user feedback pertaining to the advertising content 304.

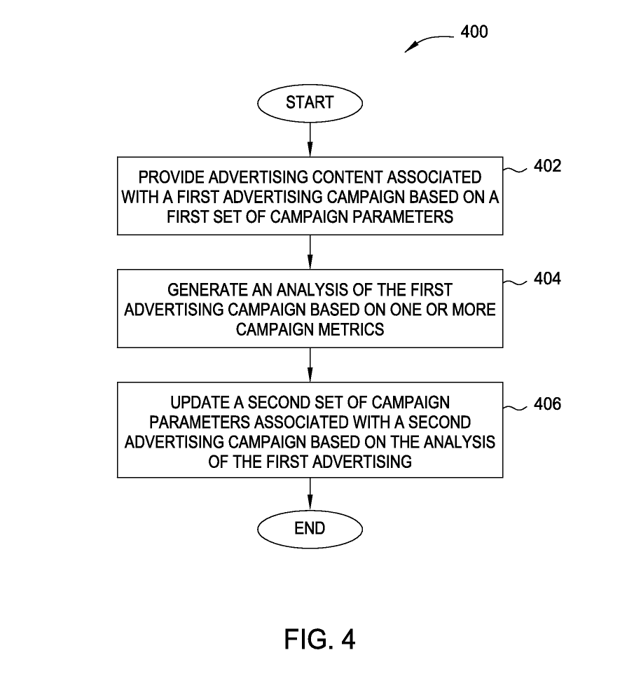

The operations of the campaign server 140 are more fully described in FIG. 4. Specifically, FIG. 4 is a flow diagram of method steps for operating multiple advertising campaigns having cross-campaign adaptation, according to one embodiment of the invention. Persons skilled in the art will understand that, even though the method 400 is described in conjunction with the systems of FIGS. 1-2, any system configured to perform the method steps, in any order, is within the scope of embodiments of the invention.

As shown, the method 400 begins at 402, where the campaign server 140 provides advertising content associated with a first advertising campaign based on a first set of campaign parameters. In other words, the advertising campaign begins running. In some embodiments, ads are delivered to users based on whether a given user has characteristics in common with a targeted audience of the advertising campaign.

In one embodiment, an advertising campaign may be defined by one or more campaign parameters selected to achieve one or more marketing objectives. The campaign parameters may include a number of instances for ad content to be served (sometimes referred to as “impressions”), an amount of time during which the advertising campaign is run (e.g., weeks, months), a target audience to whom the advertising campaign is delivered, and other advertisement settings. In some embodiments, the one or more campaign parameters are modified based on results from other advertising campaigns, such as results reflecting that the other advertising campaigns provided a particular audience with an overall lift in a particular brand metric or direct response focused conversions.

The advertising campaign may target a specific audience of users or a targeted ‘segment’. In one embodiment, the targeted audience may be represented as an audience profile having one or more targeted characteristics, or as a list of known user identifiers associated with user profiles having the one or more targeted characteristics of the audience profile. The target audience may be selected based on layering multiple types of data about consumers—including demographics, business demographics (sometimes referred to as “bizographics”), social, social psychographics, interests, lifestyle, behavioral, contextual, purchase history, offline purchase data, and search history. The target audience may also be selected from an “in-the-market-for” audience, for example, for users with demonstrated interest in automobile, financial services, consumer packaged goods, education, travel, medical, retail markets, or in markets by dint of their search intent. Embodiments of the invention may layer multiple data sources utilizing a suite of targeting algorithms, analytics, automation, and analysis to generate a target audience. In some embodiments, an initial target audience may simply be the entire general population sampled at random. In one implementation, the target audience may be represented as a list of known user identifiers, such as a persistent session identifiers or HTTP cookie described above, associated with a user profile and/or audience segment having one or more targeted characteristics.

According to embodiments of the invention, the target audience or target segment of an advertising campaign may be partitioned into one or more audience segments for analyzing and adjusting an advertising campaign with a finer granularity. Each audience segment may be further characterized by one or more audience characteristics described above, such as by demographics, lifestyles, interests, search intent, social, past purchases, behavioral data, geographic data, panel lookalikes, and browsing activity. Embodiments of the invention may transfer campaign results and insights between advertising campaigns on a per audience segment basis. In one embodiment, one or more campaign parameters may include settings that allocate a particular number of impressions to be served to a particular audience segment.

At 404, as the first advertising campaign runs, the campaign server 140 generates an analysis of the first advertising campaign based on one or more campaign metrics. A campaign metric may be any quantifiable measure of an impact of the first advertising campaign on a user or audience segment. In one embodiment, the campaign metrics may include one or more brand metrics determined before and after exposure to the first advertising campaign. A brand metric generally provides an indication of a user or audience's attitude towards or interactions with a given brand and/or product and may be represented as a quantifiable measure or score. In another embodiment of the invention, the analysis may be generated based on campaign metrics that indicate a number of prospective customers, or leads, generated from among the target audience after exposure to the first advertising campaign. In another embodiment, the campaign metrics may indicate a clickthrough rate or conversion rate for recipients of the first advertising campaign, such as a direct response campaign. In other embodiments, the campaign metrics may indicate a composition of recipients of the advertising campaign that has a particular audience characteristic sought by the advertising campaign.

As noted above, embodiments of the invention may generate the analysis by dynamically measuring the impact of the first advertising campaign on one or more brand metrics across the recipients of the advertising campaign. In some embodiments, the brand metrics may include, but is not limited to, the awareness of the existence of a product or service (i.e., “brand awareness”), an ability of a user to remember a particular branding message (i.e., “message recall”), a user's favorability towards a particular product or service (i.e., “affinity”), an intent of the user to purchase a product or service (“purchase intent”), and/or a user's active consideration of a product or service, e.g., through demonstrations or test-drives, (i.e. “consideration.”)

Embodiments of the invention utilize a variety of methodologies to determine an impact on the one or more brand metrics. In one implementation, a brand impact on the brand metric is measured using real-time, single-question survey queries. In one embodiment, the single-question survey may be configured to determine user characteristics of those users responding positively to the advertising campaign. In another embodiment, the single-question survey may be configured to measure the brand metric as related to the product and/or service of interest. As noted above, the survey question may be selected to measure brand awareness, message association, unaided message association, aided message association purchase consideration, brand favorability, intent to purchase, recommendation intent, familiarity, and other brand metrics. In other embodiments, the effect of the first advertising campaign on one or more brand metrics can be measured based on click-through rates (CTR), i.e., the number of users who interacted with an ad per ad impression, or dwell time (the time for which an ad was visible). In still further embodiments, the impact of the ad campaign on one or more brand metrics can be measured using other methodologies, techniques, or combinations thereof.

In some embodiments, the analysis may be utilized to optimize the first advertising campaign in real-time. In one embodiment, the analysis may be utilized to focus on the advertising campaign (i.e., focus impressions) on a particular audience segment having a significant lift in a desired brand metric. Similarly, the analysis may be utilized to de-allocate impressions of the advertising campaign on a particular audience segment having a poor lift in a desired brand metric.

Embodiments of the invention may generate an analysis of an advertising campaign that reflects knowledge and insights learned about recipients of the advertising campaign. In one embodiment, the analysis may include a plurality of relationships between individual customers and/or audience segments, audience characteristics, marketing messages, and brand metrics. The analysis may indicate correlations of a particular marketing message having a particular impact on a brand metric for a particular audience having a particular audience characteristic. For example, the analysis may indicate that a humorous advertising message is very effective in raising awareness of a brand and/or product with an audience segment characterized as urban-dwelling, 18-24 year-old females.

The analysis may include insights determined using a variety of statistical approaches. In one embodiment, the analysis may include insights regarding an advertising campaign's return on investment (ROI) as a function of a local hour of day when ad impressions are served (e.g., evenings perform 15% better than mornings for a given campaign). In another embodiment, the analysis may include insights regarding a particular audience segment's likelihood of engagement with a particular campaign (e.g., “frequent flyers” are over four times more likely to engage). The analysis may utilize psychographics to further characterize an audience segment with regards to their propensity to react towards a particular campaign (e.g., “extroverts,” “rebels,” and “look-before-leapers” are 30% more likely than an average user to complete a lead action). In another example, the analysis may include geographically-based insight, such as a particular state or region generating the most cost effective engagement with a campaign. In another example, the analysis may include insights regarding advertisement settings, formats, or appearance (e.g., a 160×600 pixel advertisement performs 40% better than a 728×90 pixel advertisement).

In one embodiment, the analysis may be represented as an engagement map that indicates a particular stage of interaction (i.e., state) that a particular customer and/or audience segment has with a given brand and/or product. The stages of customer interaction may be modeled based on the purchasing funnel approach described above (i.e., awareness, affinity, consideration, etc.), or by other marketing approaches. In one embodiment, the analysis may record advertising messages that a given customer and/or audience segment has already received across a number of advertising campaigns. Such analysis may be utilized by other advertising campaigns to conduct a cohesive and consistent “conversation” with the given customer and/or audience segment.

While the first advertising campaign is ongoing, the campaign server 140 concurrently executes a second advertising campaign and provides advertising content for the second advertising campaign based on a second set of campaign parameters. At 406, the campaign server 140 updates the second set of campaign parameters for the second advertising campaign based on the analysis of the first advertising campaign. The second advertising campaign may be defined by a second set of campaign parameters that may be separate and different from the first set of campaign parameters. For example, the first set of campaign parameters may define a brand advertising campaign configured to raise affinity for an automobile brand nationwide, whereas the second set of campaign parameters may define a direct response campaign configured to generate sales/leads of persons interested in purchasing a particular automobile model. In one embodiment, the campaign server 140 incorporates insight and knowledge from the analysis of the first campaign into the execution of the second campaign, as provided below. In another embodiment, the first and second campaigns may be for different forms of media. For example, the first campaign may be a television campaign; whereas, the second campaign may be a radio, print, or online campaign.

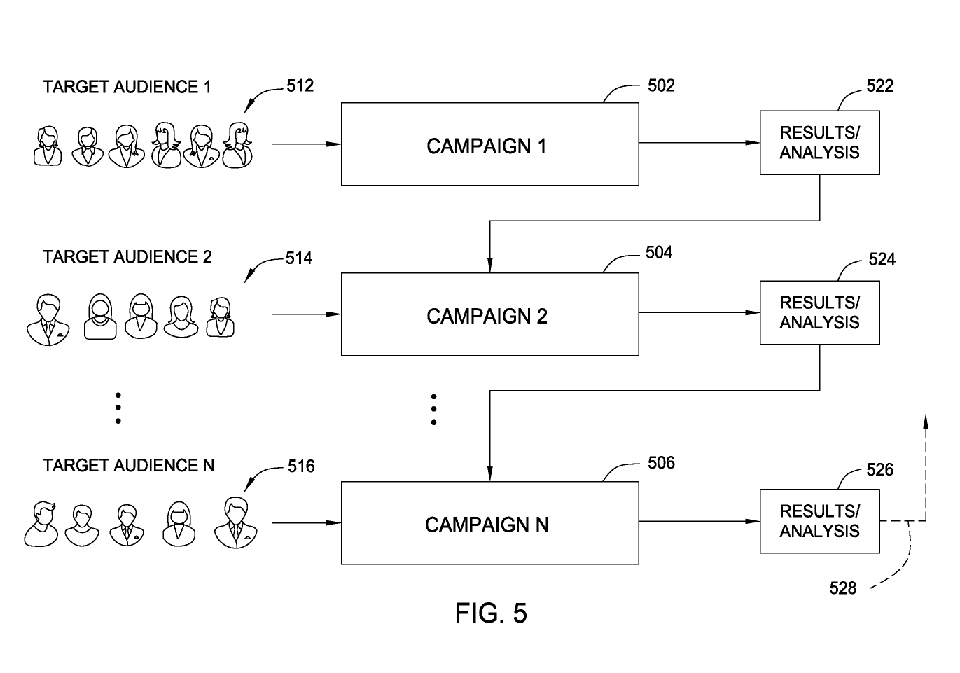

FIG. 5 is a block diagram illustrating multiple advertising campaigns managed according to certain aspects of present disclosure. Specifically, FIG. 5 illustrates a generalized embodiment of the invention configured to manage N advertising campaigns 502, 504, 506 according to the techniques described herein. In one embodiment, the advertising campaigns 502, 504, 506 may be executed in parallel, concurrently, and in real-time. A first advertising campaign 502 may be configured to achieve a first set of one or more marketing objectives, and as shown, is configured to reach a first target audience 512 of users. As the first advertising campaign 502 is being executed, results and/or analysis 522 of the first advertising campaign 502 may be generated in real-time.

Embodiments of the invention provide that the results and/or analysis of a particular advertising campaign may be utilized for a “next” advertising campaign. As shown, the results and/or analysis 522 of the first advertising campaign 502 may be incorporated into the execution of a second advertising campaign 504. The second advertising campaign 504 may be configured to achieve a second set of marketing objectives and may be configured to reach a second target audience 514. In some embodiments, the second target audience may be separate and distinct from the first target audience 512. In other embodiments, the second target audience 514 may be a subset or a superset of or may intersect with the first target audience 512. In other embodiments, the results and/or analysis 522 of the first advertising campaign may indicate additional users or audience segments that may be suitable for the second advertising campaign 504 and that may be incorporated into the second target audience 514.

As in the case of the first advertising campaign 502, results and/or analysis 524 of the second advertising campaign 504 may be generated while the second advertising campaign 504 is being run. As shown, the N-th advertising campaign 506 may utilize the results and/or analysis of a previous advertising campaign (depicted in FIG. 5 as the second results and/or analysis 524 of the second advertising campaign 504). As shown, the results and/or analysis of the N-th advertising campaign 506 may loop back and may be utilized to execute the first advertising campaign 502 or the second advertising campaign 504, as depicted in a dashed line 528. It is noted that the advertising campaigns 502, 504, 506 have been illustrated in a linear fashion, where the results and/or analysis of a given advertising campaign may be utilized for a next advertising campaign. However, it is contemplated that any one of the results and/or analysis 522, 524, 526 may be utilized with any one of the advertising campaigns 502, 504, 506. Additionally, while the analysis 522, 524, 526 are depicted in FIG. 5 as separate entities, it is contemplated that the results and/or analysis of the advertising campaign 502, 504, 506 may be represented as a common, shared entity that incorporates results and/or analysis from multiple advertising campaigns and that is accessible to multiple advertising campaigns.

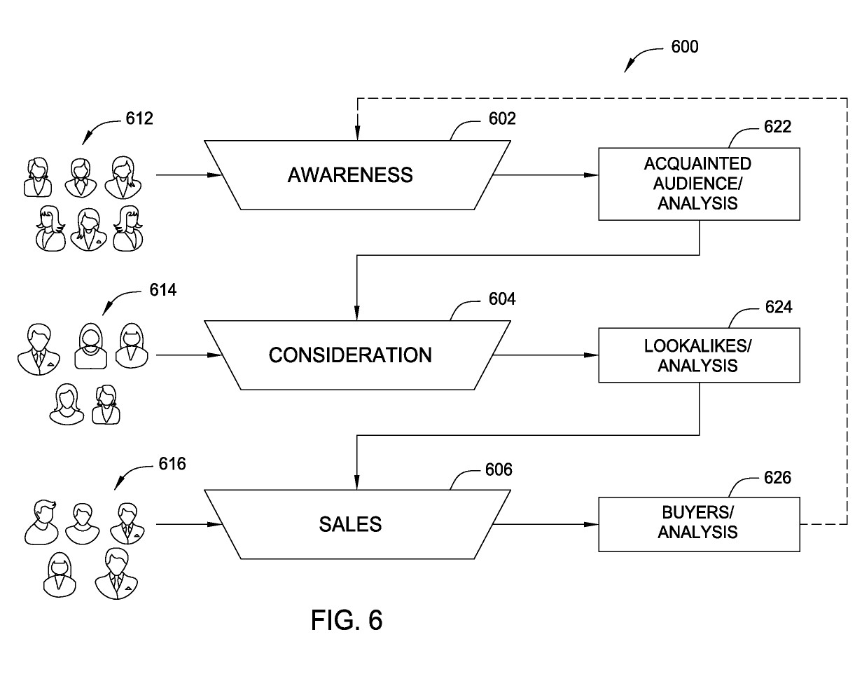

FIG. 6 is a block diagram illustrating multiple advertising campaigns 600 based on a purchasing funnel model that may be executed by embodiments of the invention. As noted above, a purchasing funnel model may be utilized for marketing objectives associated with brand awareness, affinity, consideration, purchase intent, leads, and/or sales. Accordingly, the advertising campaigns 600 may include a brand awareness campaign 602, a consideration campaign 604, and a sales campaign 606, as shown in FIG. 6.

In some embodiments, the awareness campaign 602 may be configured according to one or more campaign parameters to deliver an advertising message to a target audience 612 with the objective of raising awareness of a particular brand and/or product. In one implementation, the awareness campaign 602 may be a brand advertising campaign targeting a wide audience of users. As described above, the campaign server 140 may determine the results of the awareness campaign 602, i.e., whether or which portion of the audience 612 may be characterized as acquainted with the particular brand and/or product (“acquainted audience”). The campaign server 140 may generate an analysis 622 that includes knowledge and insight regarding how the target audience 612 responded to the awareness campaign 602.

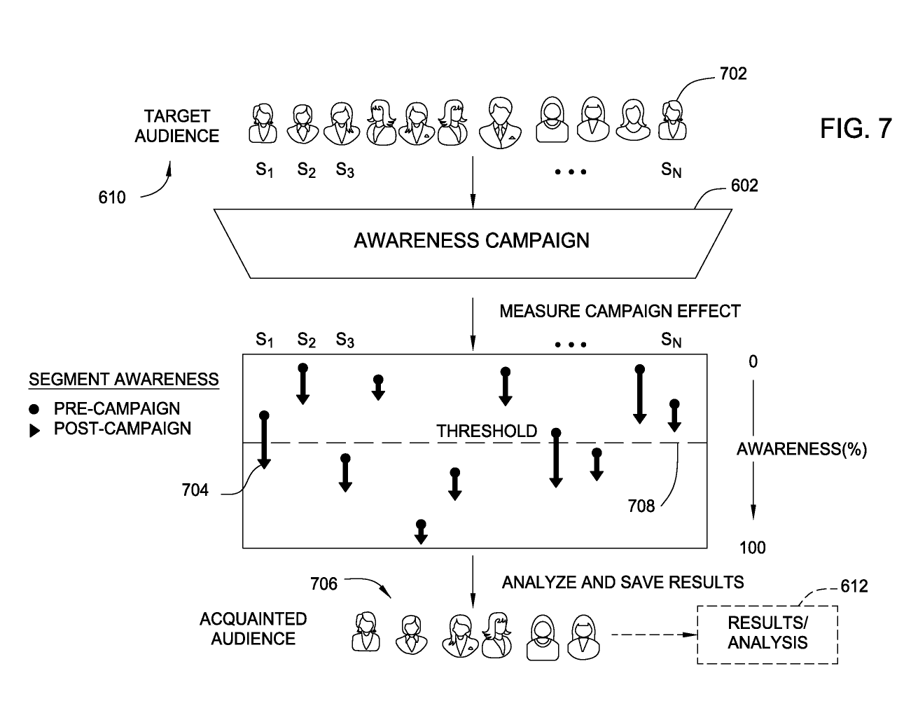

The operations of the awareness campaign 602 are more fully described in FIG. 7. FIG. 7 illustrates an example operation for generating analysis of the awareness campaign 602 according to certain aspects of present disclosure. As illustrated, a target audience 612 of the awareness campaign includes a plurality of audience segments (identified as S₁, S₂, S₃ . . . S_{N}). As shown, users of the plurality of audience segments 702 are exposed to advertising content associated with the awareness campaign. In some embodiments, the campaign server 140 measures an effect of the awareness campaign on awareness of one or more users in each of the plurality of audience segments 702, utilizing methodologies described above.

For example, the campaign server 140 may provide, for each audience segment 702, a single-question survey regarding each user's brand awareness to a sample of users exposed to advertising content of the awareness campaign and then to a control group of non-exposed users in the same audience segment. The campaign server 140 may process the survey results to determine a measure of awareness pre- and post-campaign for each audience segment 702. FIG. 7 illustrates each audience segment 702 having a corresponding graph entry 704 depicting an amount of change in awareness.

As shown, the campaign server 140 analyzes the results of the advertising campaign to harvest insights regarding the audience segments 702 in light of the awareness campaign 602. In the embodiment shown, the campaign server 140 determines a set of audience segments (depicted as an acquainted audience 706) having a post-campaign awareness score greater than or equal to a pre-determined threshold 708. In another implementation, the campaign server 140 may identify audience segments 702 having a percentage of change in awareness greater than or equal to a pre-determined threshold, i.e., audience segments 702 having the greatest “lift” in awareness based on a change in the graph entry 704.

Embodiments of the invention may analyze the acquainted audience 706 to determine particular characteristics of the audience segments that may be related to a particular response to the awareness campaign. In other words, the analysis 622 may note that a particular audience segment had a particular responsiveness towards a particular marketing message. For example, an analysis 622 may be generated to note that a given demographic responded particularly well to the awareness campaign. Such information may be utilized for optimization of the awareness campaign 602 itself and/or for adaptation of other advertising campaigns 604, 606. Conversely, the analysis 622 may identify audience segments 702 that show little to no response to the awareness campaign, where such information may be utilized to de-allocate or de-emphasize future campaign efforts towards those unresponsive audience segments. In one embodiment, the campaign server 140 may save the results and analysis 622 in storage (e.g., storage 145) for later use.

Returning to FIG. 6, the campaign server 140 also executes a consideration campaign 604 having advertising content configured to boost a user's consideration of a particular brand and/or product. As shown, the consideration campaign 604 may be executed to reach a target audience 614. The campaign server 140 may incorporate the analysis 622 (e.g., acquainted audience) from the awareness campaign 602 in the execution of the consideration campaign 604.

In one embodiment, the campaign server 140 may run the consideration campaign 604 to target an in-market audience, represented as a plurality of users. The campaign server 140 may utilize the analysis 622 to determine a set of users from the in-market audience to emphasize targeting. In one implementation, the campaign server 140 may generate an analysis 622 represented as a consideration map that plots each user based on each user's brand preference propensity (i.e., a propensity of a user to consider the particular brand and/or product, from zero to very high) versus each user's location on a purchase cycle (i.e., how far along the user is in an actual purchase, from very early to ready to purchase). For example, a user having a very high brand preference propensity and that is near ready to purchase may be characterized as a “loyalist” to the particularly brand and/or product. In another example, a user that is also near ready to purchase but has zero brand preference propensities may be deemed a “competing brand buyer.”

In one embodiment, the campaign server 140 may determine, based on the analysis 622, a set of users that have little to no brand preference propensity and are very early in the purchase cycle, and may modify the consideration campaign 604 to avoid targeting this set of users. In another embodiment, the campaign server 140 may determine a set of users based on the analysis 622 to emphasize targeting for the consideration campaign 604. An emphasized target set of users for the consideration campaign 604 may be characterized as users having a “medium” to “ready to purchase” purchase cycle attribute and a medium to high level of brand preference propensity. Other users may also be characterized based on the analysis 622, including, but not limited to “competing brand loyalists,” “potential switchers,” “first time buyers,” and “prospects.”

In one embodiment, the campaign server 140 may utilize the analysis 622 to identify a user early in a purchase cycle and boost advertising to raise consideration for a particular brand with that user. The campaign server 140 may update the state of the user in the analysis and make a notation to continue to monitor the user's activities in the purchase funnel. In another embodiment, the campaign server 140 may utilize the analysis 622 to characterize and identify a user as a competing brand loyalist. The campaign server 140 may target the competing brand loyalist for a preference campaign to drive affinity for a particular product and for a consideration campaign to boost consideration for that particular product. The campaign server 140 may update the analysis 622 to note that the competing brand loyalist, having been exposed to the previous campaigns, may be a potential switcher.

In one embodiment, the campaign server 140 may target potential switchers, as identified by the analysis 622, for a consideration campaign to drive consideration of a particular product right for the potential switchers. Further, the campaign server 140 may target the potential switchers for a direct response campaign to drive the user to take an action on a website for the particular product advertised earlier. In one embodiment, the campaign server 140 identifies a first-time buyer based on the analysis 622 and target the first-time buyer for a consideration campaign to drive consideration of a particular product. As in the case of the potential switchers, the campaign server 140 may then target the first-time buyers—that were analyzed to determine exposure to the consideration campaign—to drive the user to take action on the website or offline. In yet another embodiment, the campaign server 140 may utilize the analysis 622 to identify prospective customers, or prospects, and target the prospects with a DR campaign designed to drive the prospects to take an action on a website for the particular product.

Embodiments of the invention may utilize the analysis 622 to identify and target user “lookalikes,” i.e., users having similar characteristics as those users in an emphasized target set described above. In one embodiment, the campaign server 140 may utilize a variety of factors to perform lookalike modeling on the target audience, including, but not limited to, search intent, lifestyles, context, online behavior, past purchases, social, interests, demographics, geography, ad interaction, time of the day, and other attributes.

In another embodiment, the campaign server 140 may identify high impact promotional opportunities per audiences segment based on the analysis 622. In one implementation, the campaign server 140 may compare an awareness score (i.e., a score reflecting how aware the audience segment is of the particular brand and/or product) for each audience segment with a corresponding consideration score (i.e., a score indicating how strongly the audience segment would consider purchasing from the particular brand and/or product). The campaign server 140 may characterize audience segments having a high awareness score but low consideration as a “saturated audience.” The campaign server 140 may characterize audience segments having a low awareness score but a high consideration as an “untapped opportunity.” Accordingly, embodiments of the invention may adapt the awareness campaign 602 to increase targeting for those audience segments deemed as untapped opportunities.

As shown, the campaign server 140 generates an analysis 624 of the consideration campaign 604 having results and insights determined by the campaign server 140 during execution of the consideration campaign 604. In one embodiment, the analysis 624 may include results of lookalike modeling. In another embodiment, the campaign server 140 may incorporate the knowledge and insights of the analysis 622 from the awareness campaign 602 to generate the analysis 624.

While executing the awareness campaign 602 and/or the consideration campaign 604, the campaign server 140 may be configured to also execute a sales campaign 606 to drive sales of a particular brand and/or product based on a plurality of leads 616. The leads 616 represent one or more prospective customers and may be represented as a specific set of user cookies, or user segments as described by demographic, lifestyle, interest, in-market intent, past purchases, or other attributes. In one embodiment, the campaign server 140 may execute a direct response sales advertising campaign utilizing the leads 616. In another embodiment, the campaign server 140 may execute a sales campaign 606 to cross-sell and up-sell a particular good or product. As shown, the campaign server 140 may utilize the analysis 624 from the consideration campaign 604 to more efficiently achieve the sales objectives of sales campaign 606. For example, the campaign server 140 may utilize the analysis 624 to highlight users from among the leads 616 or to identify additional users that may be appropriate recipients of the sales campaign 606.

As shown, the campaign server 140 may generate an analysis 626 of the results of the sales campaign 606. In one embodiment, the analysis 626 may be based on users that are identified as actual buyers or purchasers of the advertised brand and/or product. The campaign server 140 may incorporate the analysis 622 and 624 to generate the analysis 626. In one embodiment, the analysis 626 may incorporate the analysis 622 and 624 to reflect how recipients of the other advertising campaigns 602 and 604 may ultimately “convert” into actual sales of a particular brand and/or product.

According to one embodiment, the campaign server 140 may utilize the analysis 626 of the sales campaign 606 to adapt and execute other campaigns, such as the awareness campaign 602, as shown via a dashed arrow in FIG. 6. In one example, the campaign server 140 may utilize analysis 626 having information about users that ultimately purchase a particular goods and/or service as a form of feedback regarding how the awareness campaign 602 may initially target users and/or audience segments. In one embodiment, the campaign server 140 may generate an analysis 626 reflecting a total cost of a sale or lead as a function of a particular brand metric. For example, the campaign server 140 may determine the total cost of all sales and/or leads as a function of brand affinity of a particular audience segment (i.e., how much a lead or sale cost for audience segments having very high or zero low brand affinity).

According to some embodiments, the advertising campaigns 600 may include additional types of advertising campaigns based on the purchasing funnel model, such as preference campaigns, affinity campaigns, and purchase intent campaigns. For example, the campaign server 140 may execute a preference campaign to deliver marketing messages configured to be compelling to a particular target audience. The preference campaign may target an acquainted audience, such as the acquainted audience 706 resulting from the awareness campaign 602, and provides advertising to raise the familiarity and preference level of the target audience to a level sufficient to create an “interested audience.” As in the case of the other campaigns 602, 604, 606, the campaign server 140 may generate an analysis of the preference campaign and store the results for later use. In another example of advertising campaigns 600, the campaign server 140 may execute a leads campaign to target high propensity prospects identified based on the analysis of the consideration campaign 604 and deliver leads more efficiently.

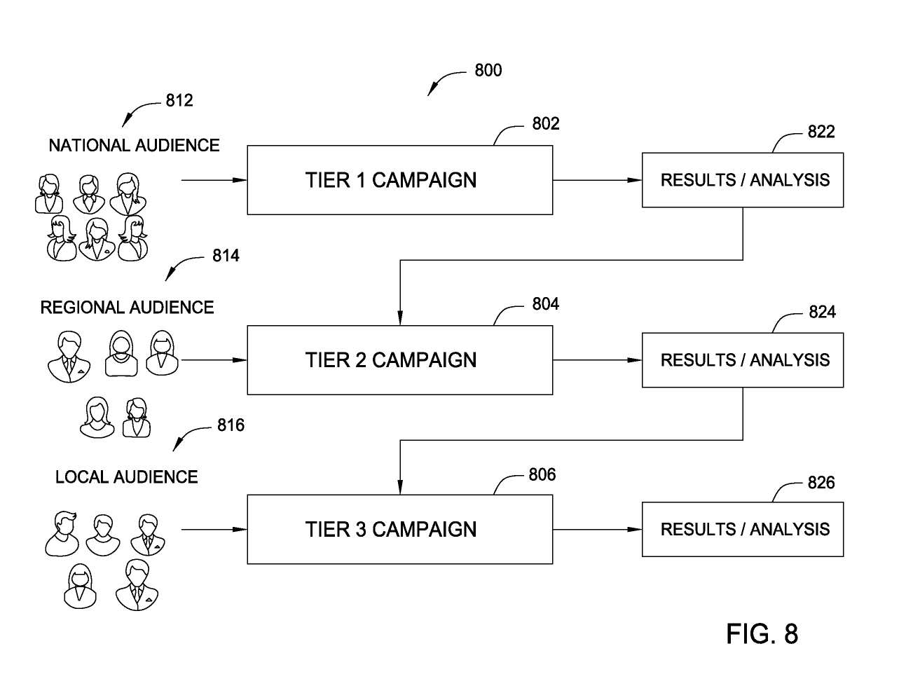

FIG. 8 is a block diagram illustrating multiple tiered advertising campaigns that may be executed using embodiments of the invention. A plurality of advertising campaigns 800 may be organized based on a business topology or ecosystem for a particular brand and/or product. In one embodiment, each advertising campaign 800 represents a different level of business organization—referred to as a “tier”—behind a particular brand and/or product. For example, a multi-national corporation may launch a nationwide brand advertising campaign (i.e., a first-tier campaign) to raise awareness and interest in the brand generally, while a regional office or branch of the corporation may execute a regional brand advertising campaign (i.e., a second-tier campaign) to generate leads and increase brand affinity in a regional area, and a local dealer may execute a local/individual store/dealership direct response campaign (i.e., a third-tier campaign) to drive individual sales of particular products of the brand.

As shown in FIG. 8, the multiple tiered advertising campaigns 800 include a first-tier campaign 802, a second-tier campaign 804, and a third-tier campaign 806 each designed to achieve a variety of marketing objectives and each configured to integrate with each of the other tier campaigns. In one embodiment, the first-tier campaign 802, second-tier campaign 804, and the third-tier campaign 806 may correspond to a national organization, a regional division, and local offices, respectively.

As shown, the first-tier campaign 802 may provide brand advertising content targeted towards a national audience 812 to achieve one or more brand-related marketing objectives, such as awareness, preference, consideration, and purchasing intent. Embodiments of the invention may execute the first-tier campaign 802 to build brand awareness and other brand metrics nationwide. As the first-tier campaign 802 is ongoing, embodiments of the invention may generate an analysis 822 having insights regarding the results of the first-tier campaign 802.

As shown, the analysis 822 may be handed off to a second-tier campaign 804 while the first-tier campaign 802 is still ongoing. Embodiments of the invention may execute the second-tier campaign 804 to provide brand advertising content to a regional audience 814 for increasing regional brand awareness. Embodiments of the invention may incorporate insights and knowledge of the analysis 822 that was gleaned from the first-tier advertising campaign 802 to more effectively execute the second-tier campaign 804. Embodiments of the invention may generate an analysis 824 based on the results of the second-tier campaign 804. As shown, embodiments of the invention may be extended to further execute a third-tier campaign 806 to provide additional direct response advertising to a local audience 816. The analysis 824 of the second-tier campaign 804 may be handed off and incorporated into execution of the third-tier campaign 806.

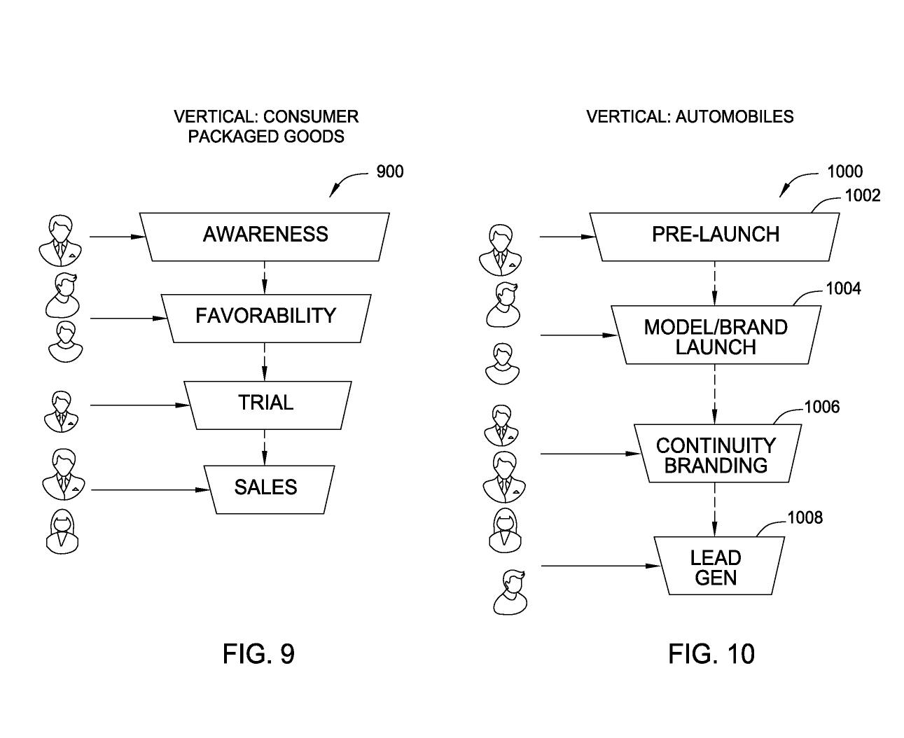

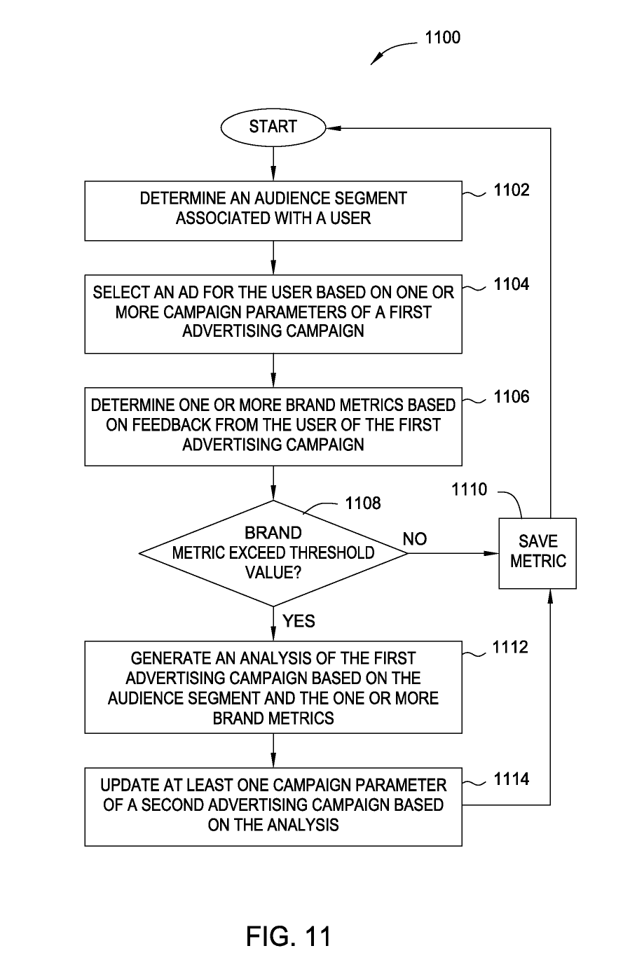

Embodiments of the invention may be adapted to administer advertising for markets with groups of businesses and/or customers engaging in a specialized trade with specific needs and parameters, sometimes referred to as “vertical markets” or “verticals.” For example, a variety of industries including consumer packaged goods (CPG), automobile, pharmaceutical, travel, retail, e-commerce, and other industries may utilize the techniques described herein to more effectively coordinate and integrate advertising campaigns across marketing levels particular to that industry. FIGS. 9-10 illustrate examples of vertical advertising campaigns that may be utilized by certain embodiments of the invention.

FIG. 9 depicts a plurality of advertising campaigns specific to a CPG industry adapted to utilize techniques of embodiments of the invention. As shown, the CPG advertising campaigns 900 may be executed to raise awareness of a particular good and/or product, increase favorability towards that good and/or product, drive consumers towards trials and samples for the good and/or product, and increase sales. Embodiments of the invention are provided to integrate and coordinate efforts and knowledge of the advertising campaigns 900 to deliver improved marketing results.

In one embodiment, the CPG advertising campaigns 900 may include brand advertising campaigns based on a branding strategy to increase awareness, consideration, purchase intent, and to leverage social effects such as affiliation and recommendations. In another embodiment, the CPG advertising campaigns 900 may include direct response advertising campaigns based on a promotional strategy utilizing events and offers. The promotional advertising campaigns may be based on events, such as holiday sales, sales events, and product launches, to increase frequency of high lifetime-value (LTV) customers. The promotional advertising campaigns may also be based on product offers, such as trials & tests, cross-sells, and up-sells to increase volume of high-frequency shoppers. Embodiments of the invention may be utilized to integrate the branding and promotional advertising campaigns.

In another embodiment, the CPG advertising campaigns 900 may be synchronized across product lines or franchises to share marketing knowledge and boost performance of the CPG advertising campaigns 900 overall. Each product line may be advertised in a dedicated, corresponding brand campaign. In one embodiment, for example, separate advertising campaigns for a large brand of personal care products may be executed for a deodorant, a razor, and a shaving gel product line. The deodorant brand campaign, the razor brand campaign, and the shaving gel brand campaign may be synchronized with each other and integrated to share knowledge utilizing techniques described herein. Additionally, each product line may also be advertised in a dedicated, corresponding direct response (DR) campaign. In the above example, a deodorant DR campaign, a razor DR campaign, and a shaving gel DR campaign may be synchronized with each other and integrated using techniques described herein. In one embodiment, the brand campaigns overall and the DR campaigns overall may be coordinated and synchronized to leverage insights across the different marketing stages for an integrated campaign strategy to optimize results for the entire franchise of products and/or goods.

FIG. 10 depicts a plurality of automobile advertising campaigns 1000 configured according to an automobile lifecycle advertising model and adapted to utilize techniques of the present disclosure. As shown, the automobile advertising campaigns 1000 include campaigns based on automobile lifecycle advertising stages, such as a “pre-launch” campaign 1002, a model/brand launch campaign 1004, a continuity branding campaign 1006, and a lead generator campaign 1008. In one embodiment, the pre-launch campaign 1002 may be a brand advertising campaign configured to spread awareness and build anticipation and buzz of a particular automobile brand or model.

Embodiments of the invention may be utilized to integrate the pre-launch campaign 1002 with a model/brand launch campaign 1004 configured to drive brand awareness and generate additional buzz for the particular automobile brand or model. The model/brand launch campaign 1004 may be a brand advertising campaign targeted to a broad audience and utilizes analysis generated from the pre-launch campaign 1002. As shown, the results of the model/brand launch campaign 1004 may be integrated with a continuity branding campaign 1006 and a lead generator campaign 1008.

The continuity branding campaign 1006 may be a brand advertising campaign for driving customer engagement with and promoting consideration of the model/brand and for reinforcing the branding messages of the pre-launch campaign 1002 and the model/brand launch campaign 1004. In one embodiment, the continuity branding campaign 1006 may reinforce branding messages with an audience segment based on the analysis of the campaigns 1002 and 1004. The lead generator campaign 1008 may be a direct response advertising campaign configured to overcome competing brands and to generate leads and buyers. The lead generator campaign 1008 may have a national or regional emphasis and may include holiday sales and special promotions. In one embodiment, the lead generator campaign 1008 may utilize the results of the model/brand launch campaign 1004 to target particular prospective customers based on insights determined during the model/brand launch campaign 1004.

It is contemplated that the automobile advertising campaigns 1000 may be executed according to a tiered campaign approach, as described in FIG. 8. For example, the automobile campaigns 1000 may integrate a national model/brand launch campaigns with regional brand and/or DR campaign and a local DR campaign.

Embodiments of the invention may be utilized to integrate advertising campaigns specific to the pharmaceutical industry. Generally, pharmaceutical campaigns may be executed in mainly two different channels: direct-to-consumer (DTC) campaigns, which target prospective patients of the pharmaceutical products, and “detailing” campaigns which target doctors and other health care professionals in online and offline marketing components. In one embodiment, the DTC campaigns may include advertising campaigns that correspond to the lifecycle stages of consumer education, physician consultation, prescription fills (i.e., sales), and adherence. In one embodiment, the detailing campaigns targeting doctors may include advertising campaigns that correspond to the marketing stages of drug awareness, physician consultation, preference, and frequent prescribers (i.e., sales). Embodiments of the invention may be utilized to coordinate DTC and detailing campaigns to improve offline detailing with insights generated from online advertising. In one embodiment, embodiments of the invention may be utilized to identify and allocate sales teams to areas characterized as high impact, based on cross-channel analysis.

Embodiments of the invention may also be utilized to integrate advertising campaigns specific to the travel and hospitality industries and share knowledge across travel brand and direct response campaigns for maximum impact. In one embodiment, travel brand advertising campaigns may be executed to raise awareness, boost association, and brand preference. In one embodiment, travel direct response campaigns that generate leads and drive sales may utilize promotions such as seasonal and fare sales, loyalty programs, and personalized offers. According to one embodiment, techniques described herein may share data and coordinate the analysis generated by each campaign's behavioral model. Travel brand advertising campaigns, which utilize branding and acquisition strategies such as frequent flier targeting, predictive modeling, and brand metric optimization, may share insights with travel direct response campaigns, which utilize travel-related direct response strategies such as travel profile targeting, research and interest-based targeting, and lifestyle targeting.

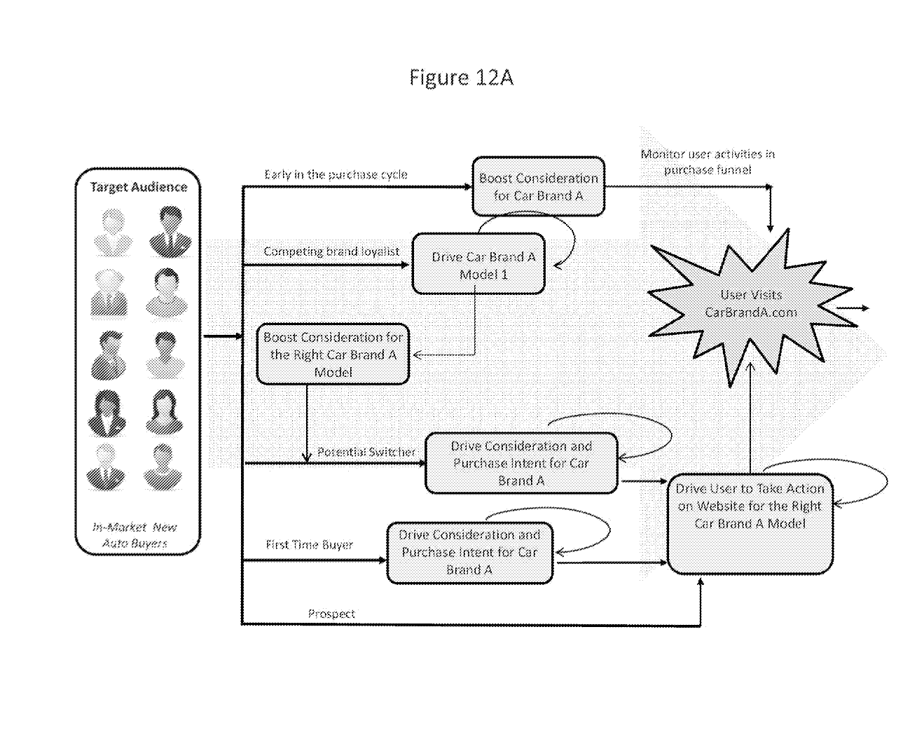

FIG. 11 is a flow diagram of method steps 1100 for serving advertising to a user utilizing a technique for cross-campaign adaptation, according to certain aspects of the present disclosure. Persons skilled in the art will understand that, even though the method 1100 is described in conjunction with the systems of FIGS. 1-2, any system configured to perform the method steps, in any order, is within the scope of embodiments of the invention.

As shown, the method 1100 begins at 1102, where the campaign controller module 224 of the campaign server 140 determines a segment or an audience segment associated with a user, and the context of the request. The campaign controller module 224 may be configured to process a request for advertising content relayed by an ad server 130 from a user. In one embodiment, the campaign controller module 224 may determine a user profile, for the given user, associated with at least one audience segment. As described above, users may be associated with segments or audience segments to analyze results of advertising campaigns with a degree of granularity.

At 1104, the campaign controller module 224 selects advertising content for the user based one or more campaign parameters of a first advertising campaign. In one embodiment, the campaign controller module 224 may determine that the user is a member of a target audience for the first advertising campaign based on the campaign parameters of the first advertising campaign. The campaign controller module 224 may provide, direct a third party component and/or server to provide, or instruct the user to request from a third-party component and/or server advertising content of the first advertising campaign.

At 1106, the campaign monitor module 226 of the campaign server 140 determines one or more brand metrics based on feedback of the first advertising campaign from the user. In one embodiment, the campaign monitor module 226 may provide a single-question survey to the user to measure a brand metric reflecting the user's interactions and/or relationship to the brand or product advertised by the first advertising campaign. For example, the campaign monitor module 226 may provide a questionnaire pertaining to the user's brand awareness. The campaign monitor module 226 may receive and process a survey response from the single-question survey to determine the brand metric. In one example, the campaign monitor module 226 may determine an awareness “score” reflecting how aware the user may be of the existence of a particular brand and/or product.

At 1108, the campaign monitor module 226 determines whether the determined brand metric exceeds a pre-determined threshold value. In one embodiment, users having brand metrics equal to or exceeding a pre-determined threshold score may be deemed as “characterized.” For example, users having a brand awareness score equal to or greater than a threshold value may be characterized as an “affected” audience or an “acquainted audience.” In one embodiment, the campaign monitor module 226 may aggregate the determined brand metric per audience segment and may characterize a given audience segment based on whether the aggregated brand metric equals or surpasses a threshold value.

Responsive to determining the brand metric does not equal or exceed the pre-determined threshold value, the campaign monitor module 226, at 1110, saves the results of the brand metric and other results in storage for later recall. The campaign server 140 may then loop and return to 1102 to wait for additional requests from users to serve advertising.

Responsive to determining that the brand metric does equal or exceed the pre-determined threshold value, at 1112, the campaign monitor module 226 may generate an analysis of the first advertising campaign based on the audience segment of the user and the one or more brand metrics. The analysis may include a correlation between the campaign parameters of the first advertising campaign, the characteristics of the audience segment, and/or the one or more brand metrics determined at 1106. In one embodiment, the campaign monitor module 226 may provide the analysis to the campaign controller module 224.

As shown, at 1114, the campaign controller module 224 updates at least one campaign parameter of a second advertising campaign based on the analysis provided by the campaign monitor module 226. The second advertising campaign may be ongoing and/or may be executed concurrently with the first advertising campaign. In one embodiment, the campaign controller module 224 may update at least one campaign parameter of the second advertising campaign to indicate that a given audience segment may be targeted by the second advertising campaign based on the analysis from 1112. As shown, the campaign monitor module 226 may save the results of the brand metric and/or the analysis at 1110, and then loop and return to 1102 to wait for additional requests from users to serve advertising.

In some embodiments, the updates to the campaign parameters may be static (i.e., manual) or dynamic (i.e., automatic). In one embodiment, the campaign parameters may be based on audience segments of individuals. After a campaign metric, such as brand impact, is measured, a particular group of individuals or segments may be identified as responding positively to the first advertising campaign. Based on this identification, the campaign parameters of a second advertising campaign may be updated. Updating the campaign parameters of the second advertising campaign may be done manually by a person that reviews the data or automatically by a software program configured to determine positive responses based on the lift in the particular metric being analyzed. In one embodiment, the “lift,” or increase, in a metric (across exposed and control groups) is used to identify positive responses to the first ad campaign, and not the absolute value of the metric.

Additionally, it is contemplated that some embodiments of the invention may implement a model-based approach instead of a segment-based approach. As described, in a segment-based approach, the first advertising campaign maybe analyzed on a per-audience segment basis, i.e., correlations are established between segments that in aggregate exhibit a significant response to the first advertising campaign. In a model-based approach, there is no concept of audience segments. Rather, a data mining model tracks responses to survey questions and learns to predict a propensity score for each user to whom an ad is displayed. The propensity score may be associated with a probability that the user will respond to the survey and/or a prediction of how the user will respond to the survey. In one embodiment, the propensity score may comprise one of three values, including a positive score, a negative score, or a neutral score. In other embodiments, any technically feasible scoring system may also be implemented. In some embodiments, implementing a model-based approach provides more refined results compared to implementing a segment-based approach since the model-based approach mines data at the individual level rather than at the segment level. For example, while a first segment may score relatively more favorably than a second segment on the average, there may be many individuals in the first segment that do not score favorably. A model based approach is able to boost performance further (as compared to a segment based approach) by only focusing on individuals who score favorably.

Accordingly, embodiments of the invention may dynamically integrate a plurality of advertising campaigns to share knowledge and insights generated based on customers' reaction to at least one of the advertising campaigns. Embodiments of the invention advantageously leverage knowledge captured during campaigns' execution and provide synergies across different advertising channels, initiatives, teams and/or time that may otherwise be lost to so-called “silo” effects. Embodiments of the invention also increase message alignment with customers to reduce repetitive, irrelevant, and misaligned messages, thereby improving a customer's overall experience with a particular brand and/or product. Embodiments of the invention also advantageously reduce waste and redundancy in media spending across campaigns.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

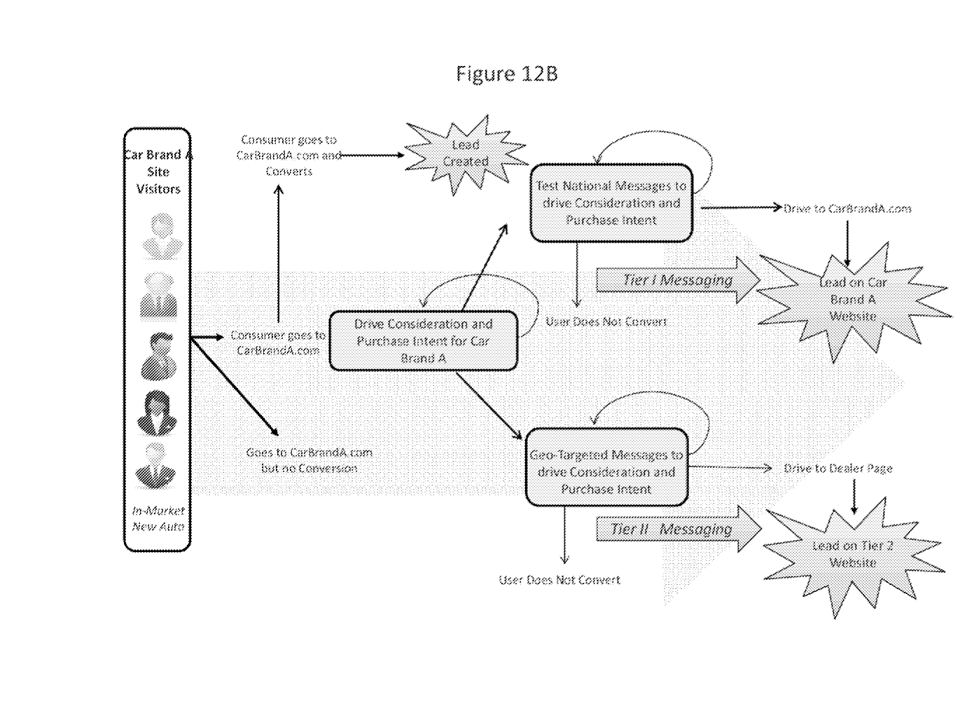

Thus far, the embodiments have mainly focused upon a linear flow of campaigns. However, campaigns are not always linear. In other words, flows across campaigns may be non-linear. The customer takes a journey with a particular brand during the customer lifecycle. FIGS. 12A and 12B show an example of various customer journeys for Car Brand A. As shown in FIG. 12A there is a target audience that comprises in-market new auto buyers. The members of the target audience may be at various stages in the process. Some members may be early in the purchase cycle. Thus, consideration for Car Brand A must be boosted, such as by impressions from an ad server (or, as will be discussed further below, through other advertising channels and methods). The ad server can then monitor the member's activities in the purchase funnel.

Other members of the target audience may include loyalists of a competing brand, such as Car Brand B. To get the loyalist to the Car Brand A website, the loyalist may follow a different path than the target audience member who is early in the purchase cycle. For example, the loyalist may drive or ride in a car from Car Brand A, such as by way of a rental car or perhaps a friend's car. After the loyalist has ridden in the car, the loyalist may like the car and become a potential switcher (i.e., no longer loyal to Car Brand B, but rather, open to purchasing from Car Brand A).

Potential switchers need some more encouragement to visit the website for Car Brand A and thus consideration and purchase intent for Car Brand A needs to be driven, just as occurs for a first time buyer. Driving the consideration and purchase intent can occur through any number of channels along the journey such as through online impressions or through conventional non-electronic based advertising. After driving consideration and purchase intent, the consumer then hopefully takes action and visits the website for Car Brand A, just as occurs for an audience member who is merely a prospect.

Once the target audience member has visited Car Brand A's website, a new audience segment is formed as shown in FIG. 12B. The new audience segment comprises those who have visited Car Brand A's website. Some of the audience members who visit the website may convert (La, sign up for a test drive, schedule an appointment with a dealer, request information regarding Car Brand A, etc.) and thus become a lead (i.e., a potential purchaser of a car from Car Brand A). Others will not convert at all. A lot can happen on the journey from visiting the website to either converting or not converting. An ad server may continually drive consideration and purchase intent for Car Brand A through impressions. National messages (i.e., advertising through billboards, commercials, etc) may be used to further drive consideration and purchase intent. Geographically targeted messages to drive consideration and purchase intent may also be used. Ultimately, the audience member will either convert or not convert. Nonetheless, there is quite a journey from being a target audience member to converting, and the journey may be different for each audience member. Additionally, various campaigns interact with the audience member along the journey.

It is important to understand that the customer journey may not necessarily be a quick journey. In fact, the customer journey from target audience member to converter can occur over a substantial period of time, such as up to a year. During the journey, multiple campaigns, such as internet advertising campaigns, national advertising campaigns, geographical advertising campaigns, etc. may affect the customer and assist in moving the customer along the journey towards conversion. For online advertising, the customer may be exposed to numerous different online advertising campaigns throughout the journey and each of those online advertising campaigns generate useful data for the ad server. The ad server can continue to gather data and utilize the gathered data to target impressions to the customer (or others similarly situated) based upon where the customer may be in the journey. In other words, the data gathered from one campaign may be seamlessly utilized in other campaigns in the customer's journey because each advertising campaign generates data that is useful for sharing and utilizing in other campaigns.

Each advertising campaign generates learning units (i.e., the data) that are put into an insights vault. Each learning unit is associated with metadata that describes what the learning unit is about (i.e., which advertiser, which vertical industry, which product, what product category, what stage of the funnel/customer lifecycle, what campaign objectives, what attributes and features worked well, etc.). The learning unit is then semantically expanded. For example, if a particular learning unit shows that people with income over $100 k responded well to impressions, then it is likely that the data for that particular learning unit may be applicable to people living in an affluent neighborhood, such as Beverly Hills. Thus, the learning unit is expanded to apply appropriately across other related campaigns (such as campaigns for the same advertiser, same industry, different stages of the funnel/customer lifecycle, different channels, etc.).

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

What is claimed is:

1. A method for managing advertising campaigns, comprising:
providing advertising content associated with a first advertising campaign to a plurality of users based on a first set of campaign parameters;
generating an analysis of the first advertising campaign based on one or more campaign metrics, wherein the one or more campaign metrics are indicative of an impact on the first advertising on at least one of the plurality of users; and
updating a second set of campaign parameters for a second advertising campaign based on the analysis of the first advertising campaign.

2. The method of claim 1, further comprising providing advertising content associated with the second advertising campaign to the plurality of users based on the updated second set of campaign parameters.

3. The method of claim 1, wherein generating the analysis comprises:
partitioning the plurality of users into a plurality of audience segments based on an audience characteristic; and
determining at least one correlation between an audience segment and one of the campaign metrics.

4. The method of claim 3, wherein generating the analysis further comprises:
determining the audience segment having a corresponding campaign metric equal to or greater than a pre-determined threshold value.

5. The method of claim 1, wherein the analysis comprises at least one correlation between a user and a marketing message, the at least one correlation indicating the user's responsiveness to the marketing message.

6. The method of claim 1, wherein the analysis comprises a record of exposure and response of one or more of the plurality of users to the first and second advertising campaigns.

7. The method of claim 1, wherein the generating the analysis comprises:
determining the one or more campaign metrics for the plurality of users before and after exposure to the first advertising campaign.

8. The method of claim 1, further comprising:
providing advertising content of the second advertising campaign based on the updated second set of campaign parameters;
updating the analysis of the first advertising campaign based on one or more campaign metrics of the second advertising campaign;
providing advertising content associated with a third advertising campaign based on a third set of campaign parameters and the updated analysis of the first advertising campaign.

9. The method of claim 1, wherein the first advertising campaign comprises a brand advertising campaign and the second advertising campaign comprises a direct response advertising campaign.

10. The method of claim 1, wherein the one or more campaign metrics are selected from a group comprising brand awareness, message association, unaided message association, aided message association, purchase consideration, brand favorability, intent to purchase, recommendation intent, and familiarity.

11. A computer-readable storage medium storing instructions that, when executed by a processor, performs an operation for managing advertising campaigns, the operation comprising:
providing advertising content associated with a first advertising campaign to a plurality of users based on a first set of campaign parameters;
generating an analysis of the first advertising campaign based on one or more campaign metrics, wherein the one or more campaign metrics are indicative of an impact on the first advertising on at least one of the plurality of users; and
updating a second set of campaign parameters for a second advertising campaign based on the analysis of the first advertising campaign.

12. The computer-readable storage medium of claim 11, wherein the operation further comprises:
providing advertising content associated with the second advertising campaign to the plurality of users based on the updated second set of campaign parameters.

13. The computer-readable storage medium of claim 11, wherein the operation comprising generating the analysis further comprises:
partitioning the plurality of users into a plurality of audience segments based on an audience characteristic; and
determining at least one correlation between an audience segment and one of the campaign metrics.

14. The computer-readable storage medium of claim 13, wherein the operation comprising generating the analysis further comprises:
determining the audience segment having a corresponding campaign metric equal to or greater than a pre-determined threshold value.

15. The computer-readable storage medium of claim 11, wherein the analysis comprises at least one correlation between a user and a marketing message, the at least one correlation indicating the user's responsiveness to the marketing message.

16. The computer-readable storage medium of claim 11, wherein the analysis comprises a record of exposure and response of one or more of the plurality of users to the first and second advertising campaigns.

17. The computer-readable storage medium of claim 11, wherein the operation comprising generating the analysis further comprises:
determining the one or more campaign metrics for the plurality of users before and after exposure to the first advertising campaign.

18. The computer-readable storage medium of claim 11, wherein the operation further comprises:
providing advertising content of the second advertising campaign based on the updated second set of campaign parameters;
updating the analysis of the first advertising campaign based on one or more campaign metrics of the second advertising campaign;
providing advertising content associated with a third advertising campaign based on a third set of campaign parameters and the updated analysis of the first advertising campaign.

19. The computer-readable storage medium of claim 11, wherein the first advertising campaign comprises a brand advertising campaign and the second advertising campaign comprises a direct response advertising campaign.

20. The computer-readable storage medium of claim 11, wherein the one or more campaign metrics are selected from a group comprising brand awareness, message association, unaided message association, aided message association, purchase consideration, brand favorability, intent to purchase, recommendation intent, and familiarity.

21. A method for administering a plurality of advertising campaigns, comprising:
determining an audience segment associated with a user;
selecting an ad for the user based on one or more campaign parameters of a first advertising campaign;
determining a score for one or more brand metrics based on feedback from the user of the first advertising campaign;
generating an analysis of the first advertising campaign based on the audience segment and the score for one or more brand metrics; and
updating at least one campaign parameter of a second advertising campaign based on the analysis.
